(19) United States
(12) Patent Application Publication
(10) Pub. No.: US 2012/0032783 A1
(43) Pub. Date: Feb. 9, 2012

(54) ELECTRONIC READER SYSTEM WITH EXTERNAL DISPLAY INTERFACE AND METHOD OF OPERATION THEREOF

(75) Inventors: Sun H. Ahn, Ladera Ranch, CA (US); Shrirang N. Jambhekar, Chino Hills, CA (US); Mei Lu, Irvine, CA (US); Sophia H. Sung, Irvine, CA (US); Yuchang Hu, Cupertino, CA (US)

(73) Assignee: SAMSUNG ELECTRONICS CO., LTD., Gyeonggi-Do (KR)

(21) Appl. No.: 13/118,217

(22) Filed: May 27, 2011

Related U.S. Application Data
(60) Provisional application No. 61/372,071, filed on Aug. 9, 2010.

(51) Int. Cl. G06K 7/01

(52) U.S. Cl. 340/6.1

(57) ABSTRACT

A method of operation of an electronic reader system includes: identifying a content attribute of a content block on a displayable page; determining a first display capability of a first display device associated with the content attribute; determining a second display capability associated with the content attribute from a communication port, the communication port for connecting with a second display device having the second display capability; ranking the second display capability against the first display capability; and processing the content block for displaying on the second display device when the second display capability is ranked higher than the first display capability.

### CROSS-REFERENCE TO RELATED APPLICATION(S)

This application claims the benefit of U.S. Provisional Patent Application Ser. No. 61/372,071 filed Aug. 9, 2010, and the subject matter thereof is incorporated herein by reference thereto.

### TECHNICAL FIELD

The present invention relates generally to an electronic system, and more particularly to an electronic reader system with an external display.

### BACKGROUND ART

Modern portable consumer and industrial electronics, especially client devices such as electronic reader systems, cellular phones, portable digital assistants, and combination devices, are providing increasing levels of functionality to support modern life including distributing and displaying multimedia books. Research and development in the existing technologies can take a myriad of different directions.

One resulting technology can provide multiple multimedia applications with multiple multimedia files, such as electronic books or electronic videos readable on an electronic reader (e-reader). As users become more empowered with the growth of e-reader devices, new and old paradigms begin to take advantage of this new device space. There are many technological solutions to take advantage of this new portable reader device opportunity. However, the tools available are often not efficient in properly displaying contents in these portable reader devices.

Thus, a need still remains for an electronic reader system to provide user with additional display option. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of an electronic reader system including: identifying a content attribute of a content block on a displayable page; determining a first display capability of a first display device associated with the content attribute; determining a second display capability associated with the content attribute from a communication port, the communication port for connecting with a second display device having the second display capability; ranking the second display capability against the first display capability; and processing the content block for displaying on the second display device when the second display capability is ranked higher than the first display capability.

The present invention provides an electronic reader system including: a content read module for identifying a content attribute of a content block on a displayable page; a discover module, coupled to the content read module, for determining a first display capability of a first display device and a second display capability of a second display device, both associated with the content attribute; a rank module, coupled to the discover module, for ranking the second display capability against the first display capability; and a render module, coupled to the rank module, for processing the content block for displaying on the second display device when the second display capability is ranked higher than the first display capability.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic reader system with an external display interface in an embodiment of the present invention.

FIG. 2 is an exemplary block diagram of the electronic device of the electronic reader system of FIG. 1.

FIG. 3 is an example of an operation of the electronic reader system of FIG. 1.

FIG. 4 is a specific example of a flow chart of a method of operation of the electronic reader system of FIG. 1.

FIG. 5 is a control flow of the electronic reader system of FIG. 1.

FIG. 6 is a flow chart of a method of operation of the electronic reader system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a camera, a camcorder, a microelectromechanical system (MEMS), passive devices, or a combination thereof.

The term “multimedia” referred to herein can include at least text, audio, still images, animation, video, interactivity content forms, or a combination thereof.

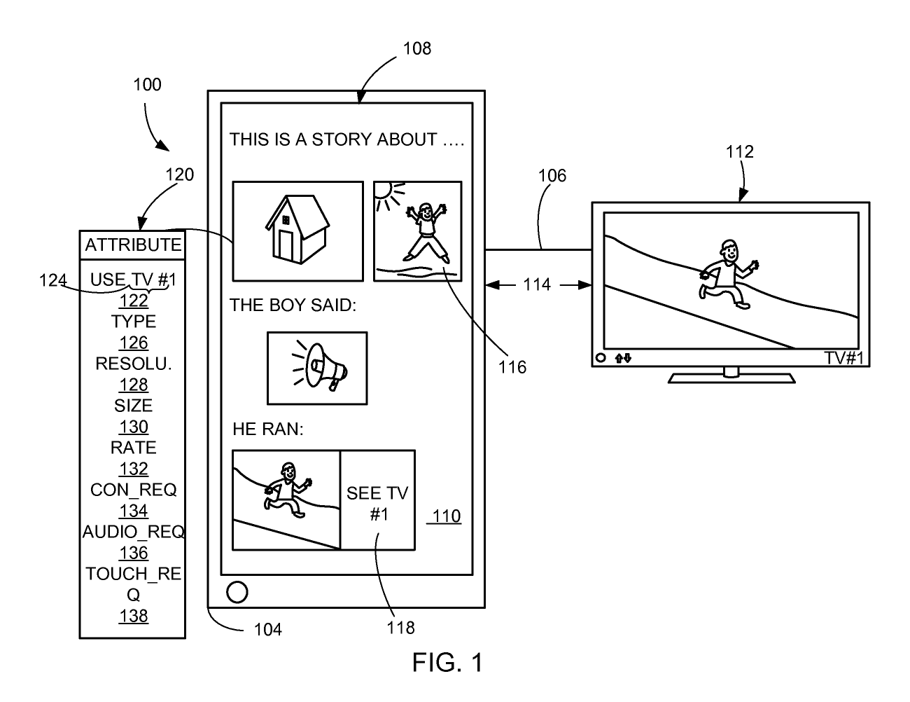

Referring now to FIG. 1, therein is shown an electronic reader system 100 with an external display interface in an embodiment of the present invention. The electronic reader system 100 can include an electronic device 104. The electronic device 104 is defined as an apparatus having digital or analog circuitry. For example, the electronic device 104 can be of any of a variety of mobile devices, such as an e-reader, a cellular phone, personal digital assistant, a notebook computer, a tablet PC, a tabletop computer, a smart surface, or other multi-functional mobile communication or entertainment device. The electronic device 104 can be a standalone device, or can be incorporated with a larger electronic system, for example a home theatre system, a personal computer, or a vehicle. The electronic device 104 can couple to a communication port 106 to communicate with external devices, such as external displays.

For illustrative purposes, the electronic device 104 is described as a mobile computing device, although it is understood that the electronic device 104 can be different types of computing devices. For example, the electronic device 104 can also be a non-mobile computing device, such as a server, a server farm, or a desktop computer.

In another example, the electronic device 104 can be a particularized machine, such as a mainframe, a server, a cluster server, rack mounted server, or a blade server, or as more specific examples, an IBM System z10™ Business Class mainframe or a HP ProLiant ML™ server. Yet another example, the electronic device 104 can be a particularized machine, such as a portable computing device, a thin client, a notebook, a netbook, a smartphone, personal digital assistant, or a cellular phone, and as specific examples, an Apple iPad™, an Apple iPhone™, Palm Centro™, or Moto Q Global™.

The communication port 106 can be a variety of networks. For example, the communication port 106 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication port 106.

Further, the communication port 106 can traverse a number of network topologies and distances. For example, the communication port 106 can include direct connection, personal area network (PAN), local area network (LAN), metropolitan area network (MAN), wide area network (WAN) or any combination thereof.

The electronic device 104 can include a first display device 108. The first display device 108 is defined as the primary display interface for the electronic device 104 and for the electronic reader system 100. The first display device 108 can be an internal display for the electronic device 104. The first display device 108 can display a displayable page 110. The displayable page 110 is defined as an arrangement of content stored on the electronic device 104, which can be displayed on either the first display device 108, such as an internal display, or a second display device 112, such as an external display.

The second display device is defined as a supplemental display interface for the electronic reader system 100. The second display device 112 can be an external display located at a predetermined distance 114 away from the first display device 108. The second display device 112 can be, for example, a television (TV), a computer monitor, a projector, a smart table, or a pair of goggles.

The displayable page 110 can include a content block 116. The content block 116 is defined as a specific self-contained area of multimedia content embedded into the displayable page 110. Here, embedded is defined as meaning fixed within a location on the displayable page 110 and being an integral part of the multimedia content. For example, the content block 116 can be an embedded audio stream, an embedded movie to be played, an embedded picture, an embedded link, an embedded interactive form, an embedded 3D environment, or an embedded interactive image such as a browsable map.

The displayable page 110 can include an indicator 118. The indicator 118 is defined as an icon, a block of text, or other representation of the location of where the content block 116 is being displayed.

The content block 116 can include a content attribute 120. The content attribute 120 is defined as a set of digital characteristics, identifications, and requirements for presenting the content block 116. For example, the content attribute 120 can include a pre-existing tag 122 of a preset display device 124, a content type 126, a content resolution 128, a content size 130, a content frame rate 132, a contrast requirement 134, an audio requirement 136, a touch screen requirement 138, or a combination thereof.

The pre-existing tag 122 is defined as a tag created by the publisher of the content block 116 that designates the preset display device 124 to be used to display the content block 116. The content type 126 is defined as an enumerated category of content, such as a compressed image, a bitmap image, a video, an audio, or an interactive application.

The content resolution 128 is defined as the number of pixel columns (width) and the number of pixel rows (height) of the content block 116. The content size 130 is defined as the digital space required to store the content block 116. The content frame rate 132 is defined as how many consecutive images per second does the content block 116 contain.

The contrast requirement 134 is defined as the ratio of the luminance of the brightest color (white) to that of the darkest color (black) that is required for displaying the content block 116. The audio requirement 136 is defined as a flag indicating whether the content block 116 contains audio to be played. The touch screen requirement 138 is defined as a flag indicating whether the content block 116 contains interactive elements that necessitates a touch screen on a potential displaying device. The content attribute 120 can also include other attributes such as color palette requirements, accessibility requirements, form factor requirements, viewing angle requirements or password protection.

As a specific example, the content attribute 120 can be a flag noting whether the content block 116 contains only text, such as encoded text, American Standard Code for Informational Interchange (ASCII) text, text that is represented by pixels, or text that is not represented by pixels.

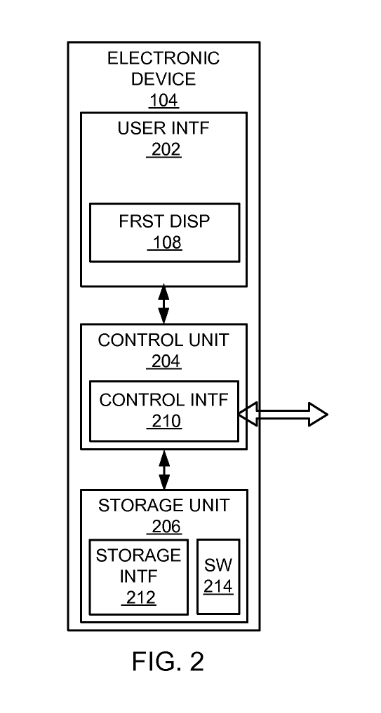

Referring now to FIG. 2, therein is shown an exemplary block diagram of the electronic device 104 of the electronic reader system 100 of FIG. 1. The electronic device 104 can include a user interface 202, a control unit 204, and a storage unit 206. The user interface 202 can include the first display device 108 of FIG. 1. The control unit 204 can include a control interface 210. The storage unit 206 can include a storage interface 212.

The user interface 202 allows a user to interface and interact with the electronic reader system 100. The user interface 202 can include an input device and an output device. Examples of the input device of the user interface 202 can include a keypad, a touchpad, soft-keys, a keyboard, a microphone, a touch pad, a camera, a webcam or a combination thereof to provide data and communication inputs.

The user interface 202 can include the first display device 108. Examples of the output device of the user interface 202 can include the first display device 108. The first display device 108 can include a display, a projector, a video screen, a speaker, or a combination thereof. The first display device 108 can also be a touch screen, such that inputs can be received from the first display device 108.

The control unit 204 can execute a software 214 to provide the intelligence of the electronic device 104. The control unit 204 can operate the user interface 202 to display information generated by the electronic device 104. The control unit 204 can also execute the software 214 for the other functions of the electronic device 104 or the electronic reader system 100, including receiving image information from the capturing device 102 of FIG. 1. The control unit 204 can further execute the software 214 for adjusting and updating the image information to display on or through the first display device 108 of FIG. 1.

The control unit 204 can be implemented in a number of different manners. For example, the control unit 204 can be a processor, an embedded processor, a microprocessor, a hardware control logic, a hardware finite state machine, a digital signal processor, or a combination thereof.

The control unit 204 can include the control interface 210. The control interface 210 can be used for communication between the control unit 204 and other functional units in the electronic reader system 100. The control interface 210 can also be used for communication that is external to the electronic device 104 or the electronic reader system 100.

The control interface 210 can receive information from the other functional units or from external sources, or can transmit information to the other functional units or to external destinations. The external sources and the external destinations refer to sources and destinations external to the electronic device 104.

The control interface 210 can be implemented in different ways and can include different implementations depending on which functional units or external units are interfacing with the control interface 210. For example, the control interface 210 can be implemented with a pressure sensor, an inertial sensor, a microelectromechanical system, optical circuitry, waveguides, wireless circuitry, wireline circuitry, or a combination thereof.

The storage unit 206 can store the software 214. The storage unit 206 can also store the relevant information, such as preferred settings, operating system, previous adjustments and updates, the displayable page 110 of FIG. 1, or a combination thereof.

The storage unit 206 can be a volatile memory, a nonvolatile memory, an internal memory, an external memory, or a combination thereof. For example, the storage unit 206 can be a nonvolatile storage such as non-volatile random access memory, Flash memory, disk storage, or a volatile storage such as static random access memory.

The storage unit 206 can include the storage interface 212. The storage interface 212 can be used for communication between the control unit 204 and other functional units in the electronic device 104 or the electronic reader system 100. The storage interface 212 can also be used for communication that is external to the electronic device 104 or the electronic reader system 100.

The storage interface 212 can receive information from the other functional units or from external sources, or can transmit information to the other functional units or to external destinations. The external sources and the external destinations referred to as sources and destinations external to the electronic device 104.

The storage interface 212 can be implemented differently depending on which functional units or external units are being interfaced with the storage unit 206. The storage interface 212 can be implemented with technologies and techniques similar to the implementation of the control interface 210.

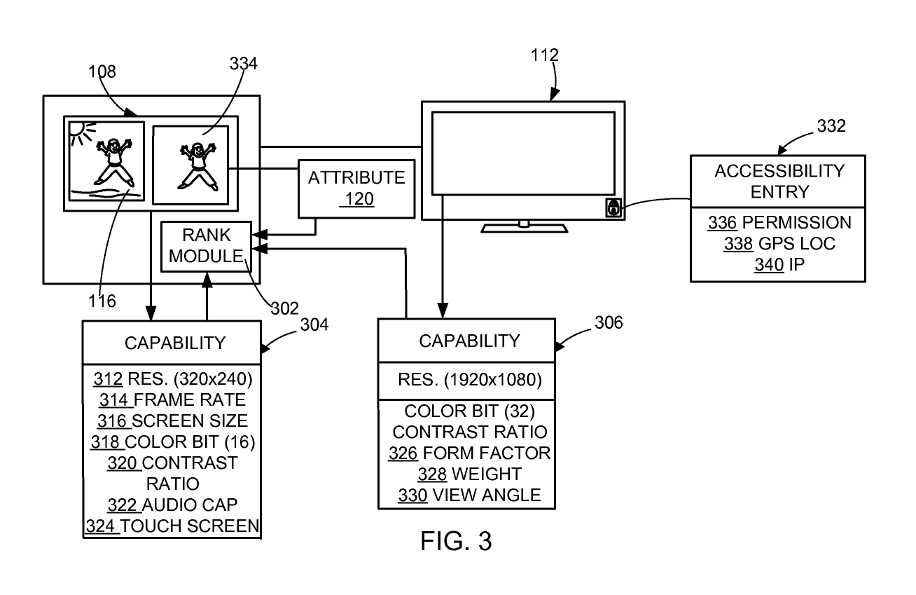

Referring now to FIG. 3, therein is shown an example of an operation of the electronic reader system 100 of FIG. 1. The electronic reader system 100 is shown to use a rank module 302 to compare a first display capability 304 of the first display device 108 to a second display capability 306 of the second display device 112. The rank module 302 is defined as a module of the electronic reader system 100 for ranking a first display capability against a second display capability to determine which one is superior for displaying, rendering, playing or executing a content block having a particular content attribute.

The first display capability 304 is defined as numeric or enumerated measures of electronic, physical, or mechanical characteristics of the first display device 108 as well as binary flags of whether the first display device 108 can display a particular type of content. The second display capability 306 is defined as numeric or enumerated measures of electronic, physical, or mechanical characteristics of the second display device 112 as well as binary flags of whether the second display device 112 can display a particular type of content. The first display capability 304 or the second display capability 306 can include at least a screen resolution capability 312, a frame refresh rate 314, a screen size 316, a color table size 318, a contrast ratio 320, an audio capable flag 322, a touch screen capable flag 324, a form factor 326, a weight 328, a view angle 330, or a combination thereof.

The screen resolution capability 312 is defined as a number or numbers of distinct pixels in each dimension that can be displayed. The frame refresh rate 314 is defined as the frequency at which a display device can produce unique consecutive images. The screen size 316 is defined as the lengthwise measure of a display device along each dimension. The color table size 318 is defined as the number of bits used to represent the color of a single pixel in a display device.

The contrast ratio 320 is defined as the ratio of the luminance of the brightest color (white) to that of the darkest color (black) that a display device is capable of producing. The audio capable flag 322 is a Boolean (yes/no) flag indicating whether a display device is capable of playing audio. The touch screen capable flag 324 is a Boolean flag indicating whether a display device has a touch screen. The form factor 326 is an enumerated measure of how portable a display device is, such as pocket-size, fixture, projector-shaped, or flexible screen.

The weight 328 is defined as the vertical force exerted by a mass of a display device as a result of gravity. The view angle 330 is defined as an angular extent that an image can be viewed from a display device. Other display capabilities can also be used to characterize a display device, such as glare resistance, power consumption, or heat dissipation.

The rank module 302 in the electronic reader system 100 can compare two capability values of the same type for determining which one of those values is better suited for rendering a content block having a certain content attribute associated with the capability values. The rank module 302 is unexpected advantageous by utilizing content differentiation with screen capability selection to provide a richer multimedia electronic book reading experience for readers, where every piece of content is displayed by the best possible device for its content type.

For example, the rank module 302 can compare a resolution capability of 320×240 for the first display device 108 to a resolution capability of 1920×1080 for the second display device 112, where the content attribute 120 of the content block 116 shows that the content block 116 can have a resolution of 1024×720. Here, the resolution numbers are defined as pixel resolution, such as the number of pixel columns (width) and the number of pixel rows (height). In the example, the rank module 302 can rank the first display capability 304 of the first display device 108 to be lower than the second display capability 306 of the second display device 112, because the resolution of the first display capability 304 is not enough to display the content block 116, while the resolution of the second display capability 306 is enough to display the content block 116.

The electronic reader system 100 can also store an accessibility entry 332 of the second display device 112 for future linkage of the second display device 112 to the electronic device 104 when displaying a similar content 334 having the content attribute 120. The accessibility entry 332 is defined as a set of basic information and requirements for utilizing a device to render content blocks. The accessibility entry 332 can include, for example, at least: a usage permission 336, a physical location 338, a digital location 340, or a combination thereof. The similar content 334 is defined as a content box having at least one of the same content attribute 120 as that of the content box 116.

The usage permission 336 is defined as information related to who and which device may access the display device, including password protection, time of day usage restriction, user device restriction, or other types of protections and restrictions against use. The physical location 338 is defined as a representation of where the display device is in reference to a known location, such as a GPS location, a pre-defined coordinate, or a zip code. The digital location 340 is defined as a representation of where the display device is on a network, such as an IP address.

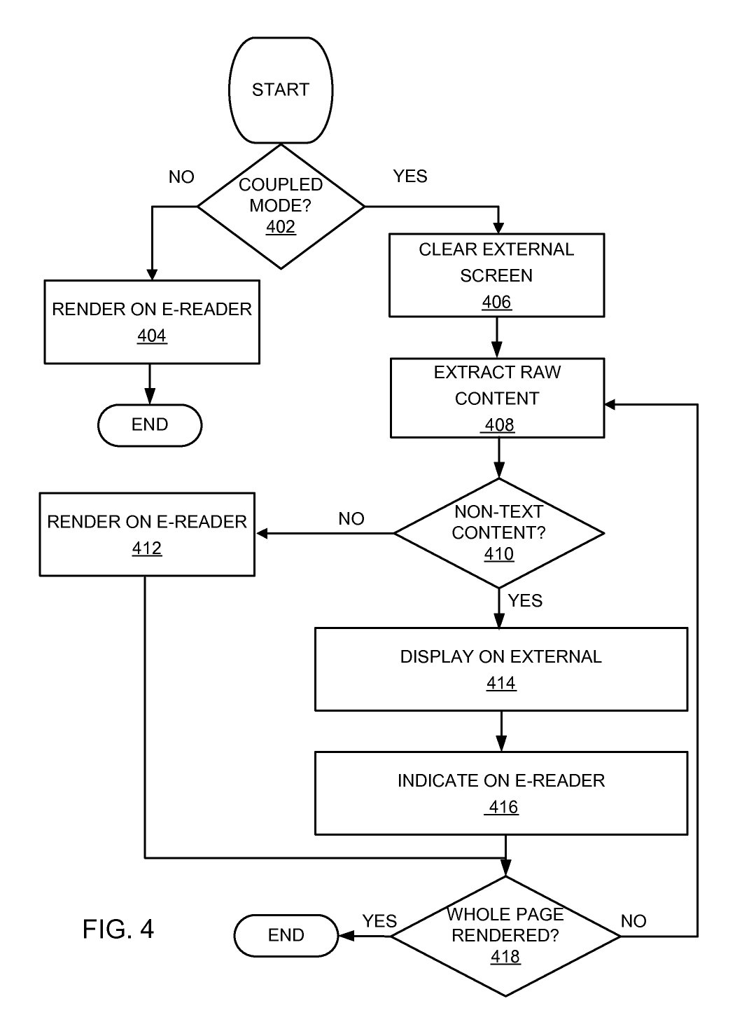

Referring now to FIG. 4, therein is shown a specific example of a flow chart of a method of operation of the electronic reader system 100 of FIG. 1. In this specific example, the method includes determining whether the electronic reader system 100 is operating in a coupled mode, in a step 402. The method includes rendering contents on a built-in display of the electronic reader system 100 and ending the process when not in the coupled mode, in a step 404.

On the other hand, the method includes clearing an external screen of an external display device when the electronic reader system 100 is operating in the coupled mode, in a step 406. After the step 406, the method then includes extracting raw content for the content block 116 of FIG. 1 from the displayable page 110 of FIG. 1, in a step 408.

After raw content is extracted, the method further includes determining whether the raw content is non-text multimedia content, in a step 410. In a first scenario, the method includes rendering the raw content on the built-in display of the electronic reader system 100 when the raw content is not non-text multimedia content and continuing on to a step 418, in a step 412. In a second scenario, the method includes displaying the raw content on an external display device when the raw content is non-text multimedia content, in a step 414. After the step 414, the method includes displaying either the raw content, an icon, or indication of the raw content on the built-in display, in a step 416.

The method in this example can terminate after determining whether the displayable page 110 of raw contents are rendered in a step 418. If the displayable page 110 is completely rendered, then the method in the example terminates. Otherwise, the method proceeds back to the step 408.

In the specific example, the electronic reader system 100 is configured such that, when the electronic reader system 100 can detect the content block 116 containing non-text content such as image/video in the displayable page 110 to be rendered. When the content block 116 containing non-text content is detected, the electronic reader system 100 automatically transmits the content block 116 to the second display device 112 of FIG. 1 by sending a handshake signal to the second display device 112. The transmitted non-text content is then displayed on the second display device 112, while the electronic reader system 100 can display on the first display device 108 all of the displayable page 110, or only text portions of the displayable page 110.

The first display device 108 of FIG. 1 and the second display device 112 can be used together in a pairing process that identifies each other. For example, when a user starts to use the electronic device 104 to access multimedia content such as an electronic book, the electronic device 104 checks whether the second display device 112 is currently available or not. If the second display device 112 is available, the electronic device 104 operates in a coupled-mode, otherwise the electronic device 104 operates in a stand-alone mode.

The stand-alone mode is defined as an operation of the electronic reader system 100 where there is only one single display for the displayable page 110. The coupled mode is defined as an operation of the electronic reader system 100 where the displayable page 110 can display portions of contents on the first display device 108, and other portions of contents on the second display device 112. For example, in the coupled mode, the non-text content can be automatically extracted for transmission to the second display device 112 for display, where the second display device 112 can be paired previously.

The displayable page 110 such as pages from electronic books can be created using several different formats, such as HTML (Hypertext Markup Language), Amazon Kindle, Adobe PDF (Portable Document Format). The electronic reader system 100 can implement some or all of the existing formats. The electronic reader system 100 can identify the content attribute 120 of each of the content block 116 based on the descriptions defined by those format specifications. The content attribute 120 indicates whether the content block 116 is text, image, video, audio clips or any other content types. Based on this information, the electronic reader system 100 can extract the content block 116 that is non-text and transmit the content block 116 to the second display device 112.

The second display device 112 can be checked to determine if it has better display capability, such as larger and/or higher definition color display. If the above check is true, the electronic reader system 100 then shows or plays the content block 116 containing the non-text content on the second display device 112. The first display device 108 can also show the content block 116 simultaneously, or show icons or symbols indicating where the content block 116 is shown, such as on the second display device 112.

It has been discovered the second display device 112 coupled to the electronic device 104 having the first display device 108 provides a more compact electronic reader system. The second display device 112 coupled to the electronic device 104 having the first display device 108 allows the electronic device 104 to separate itself from heavy display technologies such as large LCD, plasma, and projection screens, while enjoying the same powerful and rich display technologies capable of displaying a multitude of multimedia via the coupled mode. Accordingly, the second display device 112 coupled to the electronic device 104 provides a more compact electronic reader system.

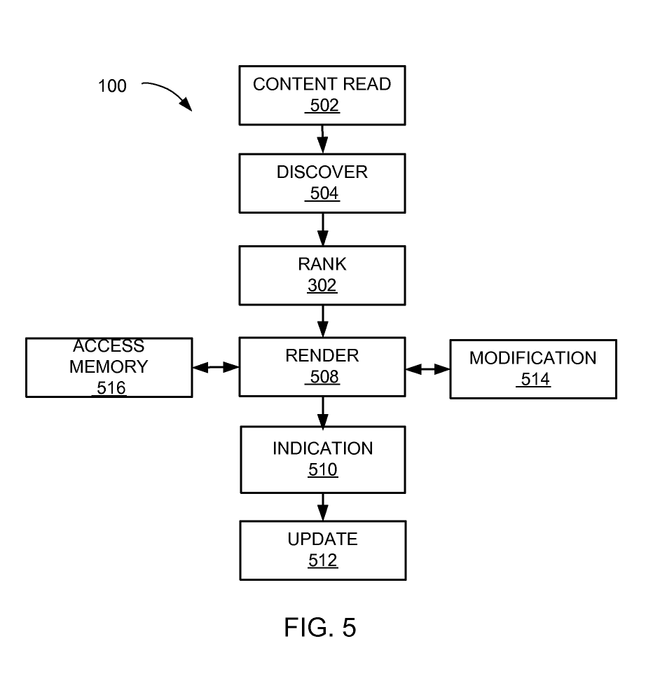

Referring now to FIG. 5, therein is shown a control flow of the electronic reader system 100 of FIG. 1. The electronic reader system 100 can include a content read module 502. The content read module 502 is a module of the electronic reader system 100 for identifying an attribute of a particular content block on a displayable page stored on the electronic reader system 100. The content read module 502 can function to identify the content attribute 120 of FIG. 1 of the content block 116 of FIG. 1 on the displayable page 110 of FIG. 1.

For example, the content read module 502 can identify that the content block 116 of the displayable page 110 has a resolution of 1024×720. As another example, the content read module 502 can identify that the content block 116 of the displayable page 110 requires a device that can play audio. As yet another example, the content read module 502 can identify that the content block 116 of the displayable page 110 is entirely black and white.

The content read module 502 can identify the content attribute 120 having at least the content type 126 of FIG. 1, the content resolution 128 of FIG. 1, the content size 130 of FIG. 1, the content frame rate 132 of FIG. 1, the contrast requirement 134 of FIG. 1, the audio requirement 136 of FIG. 1, the touch screen requirement 138 of FIG. 1, or a combination thereof. The content attribute 120 can also include the pre-existing tag 122 of FIG. 1 with the preset display device 124 of FIG. 1 for the content block 116.

It has been discovered identifying the content attribute 120 of the content block 116 on the displayable page 110 provides the electronic reader system 100 having seamless electronic book viewing experience. Identifying the content attribute 120 serves allow for determination of where to display or play such content blocks that is most representative of the contents as they were first captured. Determination of where to display or play contents saves the need for users to select specific contents to be displayed on specific display devices. Identifying the content attribute 120 further allows the electronic reader system 100 to optimize for specific devices to display small portions of the displayable page 110 without interrupting the flow of electronic book reading. Identifying the content attribute 120 of the content block 116 thereby provides a seamless electronic book viewing experience.

The electronic reader system 100 can include a discover module 504. The discover module 504 can be coupled to the content read module 502. The discover module 504 is a module of the electronic reader system 100 for determining a display capability of a first display device and a display capability of a second device, both display capabilities associated with a content attribute of a content block to be displayed. The discover module 504 can function to determine the first display capability 304 of FIG. 3 of the first display device 108 of FIG. 1 and the second display capability 306 of FIG. 3 of the second display device 112 of FIG. 1, both associated with the content attribute 120. The discover module 504 can retrieve the content attribute 120 from the content read module 502.

The discover module 504 can function to determine the second display capability 306 associated with the content attribute 120 from the communication port 106 of FIG. 1, where the communication port 106 is for connecting with the second display device 112. For example, the discover module 504 can determine display capabilities having at least a resolution attribute, a frame rate attribute, a screen size attribute, a color table size attribute, a contrast ratio attribute, an audio output attribute, a touch screen attribute, or a combination thereof. As another example, the discover module 504 can function to determine only the second display device 112 within the predetermined distance 114 of FIG. 1 of the first display device 108.

The discover module 504 can determine display capabilities by requesting such capabilities from the display devices themselves. The discover module 504 can also determine display capabilities by testing the display devices, such as sending a video signal and determining whether an error signal is returned. Display capabilities can also be determined through user input or through a database on the electronic device 104 of FIG. 1, on the display devices, or on the Internet.

The electronic reader system 100 can include the rank module 302. The rank module 302 can be coupled to the discover module 504. The rank module 302 can function to rank the second display capability 306 against the first display capability 304. The rank module 302 can retrieve the first display capability 304 and the second display capability 306 from the discover module 504.

The rank module 302 can have a list of quantifiable measures that can be associated with the content attribute 120, the first display capability 304 and the second display capability 306. Included in the list of quantifiable measures is also a directional tag indicating which direction of the quantifiable measure is the “superior” number. For example, the resolution capability 312 of FIG. 3 associated with the content resolution 128 of FIG. 1 can be in the list of quantifiable measures, where the direction tag can indicate that the higher the resolution capability 312, the more “superior” the display device is.

The rank module 302 can also have a list of enumerated measures or Boolean flags that can be associated with the content attribute 120, the first display capability 304 and the second display capability 306. Each instance of the content attribute 120 can be associated with an enumerated measure or Boolean flag. For example, the content attribute 120 can have an indication that it includes audio, such as in the audio requirement 136 of FIG. 1. The audio requirement 136 can be associated with an enumerated measure of “audio capable” in the audio capable flag 322. In this case, the rank module 302 will rank a display device having the enumerated measure of being “stereo audio capable” higher than another device without the enumerated measure. The list of quantifiable measures, enumerated measures, or Boolean flags in the rank module 302 can be provided by the publisher of the displayable page 110, a viewer of the displayable page 110, a database from a third party, or a database pre-installed within the storage unit 206 of FIG. 2.

The rank module 302 can also use the location information of the second display device 112 for ranking For example, if the content attribute 120 indicates that the content block 116 is an audio clip and the second display device 112 has a speaker, the rank module 302 can rank the second display device 112 higher than the first display device 108 when the second display device 112 is located within audible range, for example, 30 feet.

It has been discovered the rank module 302 serves to simplify complex display systems. Having the rank module 302 to rank a first display capability against a second display capability allows the electronic reader system 100 to choose which display device is best suited for a particular content block. In a system environment with a vast number of different multimedia book types and several possible display devices, the rank module 302 can simplify the system so that user selection of display devices would be unnecessary. The rank module 302 thereby provides a simplified display system by ranking display device capabilities.

The electronic reader system 100 can include a render module 508. The render module 508 can be coupled to the rank module 302. The render module 508 is a module of the electronic reader system 100 for automatically creating a linkage between the electronic device 104 and sending a block of content off to a second display whenever the block of content is detected on the displayable page 110 and determined to be a better candidate for displaying by the rank module 302.

The linkage between the electronic device 104 and the second display device 108 allows electronic device 104 to directly control the second display device 108. The render module 508 can function to send the content block 116 for displaying on the second display device 112 when the second display capability 306 is ranked higher than the first display capability 304.

For example, the render module 508 can also send the content block 116 to be displayed on both the first display device 108 and the second display device 112. The render module 508 can synchronize the display of the first display device 108 and the second display device 112 such that any changes relating to the content block 116 on the displayable page 110 shown on the first display device 108 is reflected on the second display device 112. The render module 508 can control the screen of the first display device 108, the second display device 112, or both to display the content block 116 in full screen.

The electronic reader system 100 can include an indication module 510. The indication module 510 can be coupled to the render module 508. The indication module 510 is a module of the electronic reader system 100 for generating an indicator of where a content block is being displayed on a displayable page within which the content block is embedded. The indication module 510 can function to generate the indicator 118 of FIG. 1 of where the content block 116 is being displayed. For example, the indicator 118 can be generated by creating an icon depicting a monitor or display away from the first display device 108. The indication module 510 can pass the indicator 118 generated to the render module 508 for display.

The electronic reader system 100 can include an update module 512. The update module 512 can be coupled to the render module 508. The update module 512 is a module of the electronic reader system 100 for clearing a second display device after a content block is sent off for displaying. The clearing occurs at least when the displayable page of the content block is minimized, skipped, or removed. The update module 512 can function to clear the second display device 112 after the content block 116 was sent for displaying at least when the displayable page 110 is skipped, removed, or minimized. For example, the update module 512 can clear the second display device 112 by commanding the render module 508 to show a blank screen on the second display device 112 when the displayable page 110 is minimized through a command on the electronic device 104 of FIG. 1.

The electronic reader system 100 can include a modification module 514. The modification module 514 can be coupled to the render module 508. The modification module 514 is a module of the electronic reader system 100 for modifying a block of content for displaying based on the display capability of where the block is to be displayed and the content attribute of the content block. The modification module 514 can function to modify the content block 116 for the render module 508 to send to the second display device 112, based on at least: the content attribute 120, the first display capability 304, the second display capability 306, or a combination thereof. For example, the modification module 514 can modify the content block 116 by sampling a lower frame rate given that the display capability of all available displays have a lower frame rate than the maximum frame rate of the content block 116.

The electronic reader system 100 can include an access memory module 516. The access memory module 516 can be coupled to the render module 508. The access memory module 516 is a module of the electronic reader system 100 for compiling accessibility information of a display device for reference for future linkage of the display device to the electronic reader system 100. The access memory module 516 can function to compile the accessibility entry 332 of FIG. 3 of the second display device 112 for future linkage of the second display device 112 when displaying the similar content 334 of FIG. 3 having the content attribute 120, the accessibility entry 332 including at least: usage permission, physical location, digital location, or a combination thereof.

For example, the access memory module 516 can compile the digital location and usage permission of a shared TV, such that next time when the shared TV is coupled, the electronic reader system 100 can easily access it without requiring additional information. The access memory module 516 can supply the accessibility entry 332 to the render module 508 so that the render module 508 can easily send the content block 116 for displaying on the second display device 112.

The software 214 of FIG. 2 of the electronic device 104 of FIG. 1 can include modules of the electronic reader system 100. For example, the software 214 can include the content read module 502, the discover module 504, the rank module 302, the render module 508, the indication module 510, the update module 512, the modification module 514, and the access memory module 516.

The control unit 204 of FIG. 2 can execute the software 214 for the content read module 502 to identify the content attribute 120 of the content block 116 on the displayable page 110. The control unit 204 can execute the software 214 for the discover module 504 to determine the first display capability 304 of the first display device 108 and the second display capability 306 of the second display device 112, both associated with the content attribute 120.

The control unit 204 can execute the software 214 for the rank module 302 to rank the second display capability 306 against the first display capability 304. The control unit 204 can execute the software 214 for the render module 508 to process the content block 116 for displaying on the second display device 112 when the second display capability 306 is ranked higher than the first display capability 304. The control unit 204 can execute the software 214 for the indication module 510 to generate the indicator 118 of where the content block 116 is being displayed.

The control unit 204 can execute the first display device 108 of FIG. 1 to display the content block 116 on the first display device 108 or the second display device 112. The software 214 can include the content read module 502. Based on the size of the storage unit 206 of FIG. 2, the software 214 can include additional modules of the electronic reader system 100. The control unit 204 can execute the modules partitioned on the software 214 as previously described.

The user interface 202 of FIG. 2 can receive instructions from the user, the electronic reader system 100, or a combination thereof. The control unit 204 can operate the control interface 210 of FIG. 2 to process the content block 116 to the second display device 112, such as an external display.

The content read module 502 can use the control unit 204 to identify the content attribute 120 of the content block 116 on the displayable page 110. The access memory module 516 can store the accessibility entry 332 to the storage unit 206 through the storage interface 212. The content read module 502 can access the displayable page 110 and the content attribute 120 from the storage unit 206 through the storage interface 212 as well.

The electronic reader system 100 can also be implemented as additional functional units in the electronic device 104. For example, the content read module 502 can be an additional functional unit in the electronic device 104. The electronic reader system 100 describes the module functions or order as an example. The modules can be partitioned differently. For example, the content read module 502 and the discover module 504 can be combined. Each of the modules can operate individually and independently of the other modules.

Furthermore, data generated in one module can be used by another module without being directly coupled to each other. For example, the rank module 302 can receive the content attribute 120 from the content read module 502 for ranking the first display capability 304 and the second display capability 306. For another example, the render module 508 can also receive the content block 116 from the content read module 502.

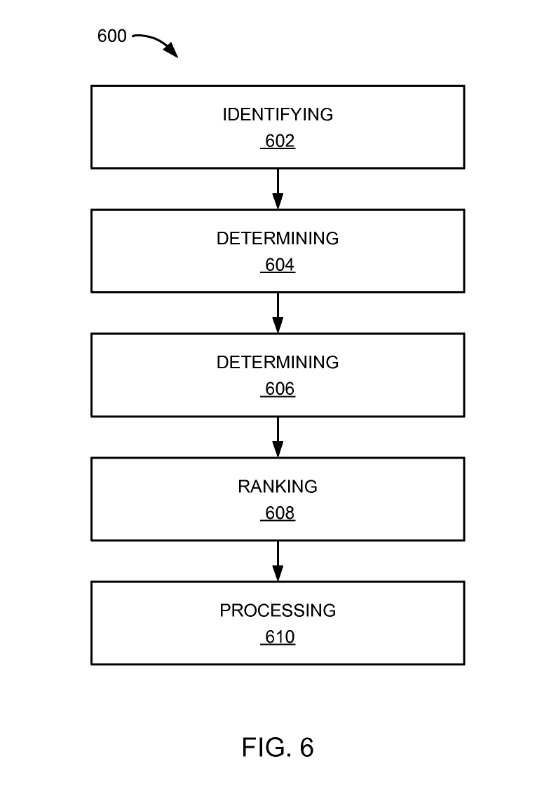

Referring now to FIG. 6 therein is shown a flow chart of a method 600 of operation of an electronic reader system in a further embodiment of the present invention. The method 600 includes: identifying a content attribute of a content block on a displayable page, in a block 602; determining a first display capability of a first display device associated with the content attribute, in a block 604; determining a second display capability associated with the content attribute from a communication port, the communication port for connecting with a second display device having the second display capability, in a block 606; ranking the second display capability against the first display capability, in a block 608; and processing the content block for displaying on the second display device when the second display capability is ranked higher than the first display capability, in a block 610.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an electronic reader system comprising:
identifying a content attribute of a content block on a displayable page;
determining a first display capability of a first display device associated with the content attribute;
determining a second display capability associated with the content attribute from a communication port, the communication port for connecting with a second display device having the second display capability;
ranking the second display capability against the first display capability; and
processing the content block for displaying on the second display device when the second display capability is ranked higher than the first display capability.

2. The method as claimed in claim 1 wherein identifying the content attribute includes identifying the content attribute having a content type, a content resolution, a content size, a content frame rate, a contrast requirement, an audio requirement, a touch screen requirement, or a combination thereof.

3. The method as claimed in claim 1 wherein determining the second display capability includes determining the second display capability having a screen resolution, a frame refresh rate, a screen size, a color table size, a contrast ratio, an audio capable flag, a touch screen capable flag, a form factor, a weight, a view angle, or a combination thereof.

4. The method as claimed in claim 1 further comprising clearing the second display device after the content block was sent for displaying when the displayable page is skipped, removed, or minimized.

5. The method as claimed in claim 1 further comprising modifying the content block for displaying based on the content attribute, the first display capability, the second display capability, or a combination thereof.

6. A method of operation of an electronic reader system comprising:
identifying a content attribute of a content block on a displayable page;
determining a first display capability of a first display device associated with the content attribute;
determining a second display capability associated with the content attribute from a communication port, the communication port for connecting with a second display device having the second display capability;
ranking the second display capability against the first display capability;
processing the content block for displaying on the second display device when the second display capability is ranked higher than the first display capability; and
generating an indicator of where the content block is being displayed on the displayable page.

7. The method as claimed in claim 6 further comprising compiling an accessibility entry for linking the second display device when displaying a similar content having the content attribute, the accessibility entry including a usage permission, a physical location, a digital location, or a combination thereof.

8. The method as claimed in claim 6 wherein determining the second display capability includes determining a second display capability from a communication port, the communication port for connecting with a second display device within a predetermined distance of the first display device.

9. The method as claimed in claim 6 wherein processing the content block includes processing the content block for displaying on both the first display device and the second display device.

10. The method as claimed in claim 6 wherein identifying the content attribute includes identifying the content attribute having a pre-existing tag on the content block with a preset display device.

11. An electronic reader system comprising:
a content read module for identifying a content attribute of a content block on a displayable page;
a discover module, coupled to the content read module, for determining a first display capability of a first display device and a second display capability of a second display device, both associated with the content attribute;
a rank module, coupled to the discover module, for ranking the second display capability against the first display capability; and
a render module, coupled to the rank module, for processing the content block for displaying on the second display device when the second display capability is ranked higher than the first display capability.

12. The system as claimed in claim 11 wherein the content read module is for identifying the content attribute having a content type, a content resolution, a content size, a content frame rate, a contrast requirement, an audio requirement, a touch screen requirement, or a combination thereof.

13. The system as claimed in claim 11 wherein the discover module is for determining the first display capability and the second display capability having: a screen resolution, a frame refresh rate, a screen size, a color table size, a contrast ratio, an audio capable flag, a touch screen capable flag, a form factor, a weight, a view angle, or a combination thereof.

14. The system as claimed in claim 11 further comprising an update module, coupled to the render module, for clearing the second display device after the content block was sent for displaying when the displayable page is skipped, removed, or minimized.

15. The system as claimed in claim 11 further comprising a modification module, coupled to the render module, for modifying the content block for displaying based on: the content attribute, the first display capability, the second display capability, or a combination thereof.

16. The system as claimed in claim 11 further comprising an indication module, coupled to the render module, for generating an indicator of where the content block is being displayed on the displayable page.

17. The system as claimed in claim 16 further comprising an access memory module, coupled to the render module, for compiling an accessibility entry of the second display device for future linkage of the second display device when displaying a similar content having the content attribute, the accessibility entry including: a usage permission, a physical location, a digital location, or a combination thereof.

18. The system as claimed in claim 16 wherein the discover module is for determining the second display capability of the second display device, the second display device only within a predetermined distance of the first display device.

19. The system as claimed in claim 16 wherein the render module is for processing the content block for displaying on both the first display device and the second display device.

20. The system as claimed in claim 16 wherein the content read module is for identifying the content attribute having: a pre-existing tag on the content block with a preset display device.
